(19) United States
(12) Patent Application Publication
(10) Pub. No.: US 2011/0025064 A1
(43) Pub. Date: Feb. 3, 2011

(54) WIND POWER GENERATION SYSTEM AND METHOD USING STACK EFFECT OF HIGH-SPEED ELEVATOR IN HIGH-RISE BUILDING

(76) Inventor: SungHee Park, Seoul (KR)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, SUITE 280, WESTBOROUGH, MA, 01581, US

(21) Appl. No.: 12/828,427

(22) Filed: Jul. 1, 2010

(30) Foreign Application Priority Data
Jul. 29, 2009 (KR) 10-2009-0069447

(51) Int. Cl. F03D 9/02

(52) U.S. Cl. 290/50

(57) ABSTRACT

A wind power generation system using a stack effect of a high-speed elevator in a high-rise building is provided which includes: a wind turbine rotating with a wind generated from movement of an elevator car vertically moving in an internal space of an elevator core disposed in the high-rise building; a wind power generator converting kinetic energy generated with the rotation of the wind turbine into electric energy; and a storage battery storing the electric energy.

### BACKGROUND

1. Field of the Invention

The present invention relates to wind power generation system and method using a stack effect of a high-speed elevator in a high-rise building.

2. Description of the Related Art

More and more high-rise buildings have been constructed with the development of building techniques and the influence of the cityward tendency of the population. Various countries have competitively constructed the highest building in the world to promote their technical skills and their national images and the number of floors has increased.

An elevator car and an elevator core which are vertical moving means are necessarily constructed in a building. In a shaft as a vertical moving passage of the elevator car and the elevator core such as a stair room, a stack phenomenon occurs due to a pressure difference based on a weight difference between air columns inside and outside the building in a vertical empty space such as a chimney. The air column in the shaft and the core are maintained at a room temperature and the air column outside the building is maintained at the same temperature as that of the external air having the same height. In this way, the pressure difference between the inside and the outside of the building varies depending on the temperature difference between indoors and outdoors.

The pressure difference resulting from the stack effect can be considered in two parts of the upper part and the lower part of the building. The air discharged from the upper part is replaced with the air introduced into the lower part. The pressure difference between the inside and the outside of the building caused in a sectional plane by a density difference of the air varies depending on the height. The infiltration is generated in the lower part and the exfiltration is generated in the upper part with the increasing internal pressure.

The air flow caused by the pressure difference is similar to the air flow in a chimney. Accordingly, this phenomenon is called “stack effect”. The stack effect is great particularly in a high-rise building in winter where the temperature difference between indoors and outdoors increases. The stack effect causes various problems in the elevator core, that is, the stair room and the elevator shaft, and enhances the amount of infiltration in the first floor. The stack effect occurs in all the buildings.

In the past, to prevent the stack effect, a wind discharging room was disposed in an entrance of an underground parking lot of a high-rise building at the time of designing the high-rise building and a wind (an air current) generated in the elevator core was discharge to the outside via the air discharging room.

Therefore, the invention provides a solution for supplying energy used in the high-rise building by reusing the discharged wind as a wind power generation source instead of discharging the air current (wind) generated in the elevator core to the outside.

### SUMMARY

An advantage of some aspects of the invention is that it provides wind power generation system and method using a stack effect of a high-speed elevator in a high-rise building, which can supply energy used in the building by using an air current (wind) generated at the time of vertical movement of a high-speed elevator car as a wind power generation source.

Another advantage of some aspects of the invention is that it provides wind power generation system and method using a stack effect of a high-speed elevator in a high-rise building, which can effectively generate wind power by sufficiently using any irregular (chaos) and small-capacity eddy current not having a constant direction in the elevator core by the use of a gyroscopic wind turbine.

Advantages of the invention are not limited to the above-mentioned, and other advantages can be apparently understood from the following description by those skilled in the art.

According to an aspect of the invention, there is provided a wind power generation system using a stack effect of a high-speed elevator in a high-rise building, including: a wind turbine rotating with a wind generated from movement of an elevator car vertically moving in an internal space of an elevator core disposed in the high-rise building; a wind power generator converting kinetic energy generated with the rotation of the wind turbine into electric energy; and a storage battery storing the electric energy.

The wind turbine may include a plurality of wind turbines disposed in the upper part and the lower part of the elevator core and a plurality of wind turbines disposed in the upper part and the lower part of the elevator car.

The wind turbine may include a gyroscopic wind turbine in which three gimbals arranged in the X, Y, and X axis directions, respectively, are coupled into a spherical shape so as to work with winds of all directions and in which a rotor is formed in the gimbal arranged in the Y axis direction.

The wind turbine may include a small-sized wind turbine which can work with a weak wind.

The wind turbines disposed in the upper part and the lower part of the elevator car may be located in the outer edges of the upper part and the lower part of the elevator car.

The wind turbine and the wind power generator may be physically connected to each other in the elevator core, and the storage battery may be disposed in a wind power generator machine room controlling the operation of the wind power generator.

The wind power generation system may further include a converter converting the electric energy stored in the storage battery and supplying the converted electric energy to electric apparatuses in the high-rise building including the elevator.

The converter may convert the voltage level of the electric energy depending on the operation voltage levels of the electric apparatuses.

The converter may be disposed in a wind power generator machine room controlling the wind power generator.

According to another aspect of the invention, there is provided a wind power generation method using a stack effect of a high-speed elevator in a high-rise building, including the steps of: generating kinetic energy using a wind caused by movement of an elevator car vertically moving in an internal space of an elevator core disposed in the high-rise building; converting the kinetic energy into electric energy; and storing the electric energy in a storage battery.

The step of generating the kinetic energy may include rotating a wind turbine using the wind to generate the kinetic energy.

The step of converting the kinetic energy into the electric energy may include converting the kinetic energy into the electric energy using a wind power generator.

The wind power generation method may further include a step of converting the electric energy stored in the storage battery and supplying the converted electric energy to electric apparatuses in the high-rise building including the elevator.

The step of supplying the converted electric energy to the electric apparatuses may include converting the voltage level of the electric energy depending on the operation voltage levels of the electric apparatuses using an inverter and supplying the electric energy, the voltage level of which is converted, to the electric apparatuses.

Details of other aspects are included in the detailed description and the accompanying drawings.

Advantages and features of the invention and methods for putting them into practice will be apparent from the following embodiments and drawings. However, the invention is not limited to the embodiments, but can be modified in various forms. The embodiments are provided to complete the disclosure of the invention and to completely notify the scope of the invention to those skilled in the art. Like reference numerals in the drawings reference like elements. In the following description, like elements are referenced by like reference numerals or signs.

According to the above-mentioned configuration of the invention, it is possible to supply energy used in the building by using an air current (wind) generated at the time of vertical movement of a high-speed elevator car as a wind power generation source.

According to the above-mentioned configuration of the invention, it is possible to effectively generate wind power by sufficiently using any irregular (chaos) and small-capacity eddy current not having a constant direction in the elevator core by the use of a gyroscopic wind turbine.

### BRIEF DESCRIPTION OF THE DRAWINGS

FIG. 1 is a block diagram illustrating the configuration of a wind power generation system using a stack effect of a high-speed elevator in a high-rise building according to an embodiment of the invention.

FIG. 2 is a location diagram illustrating the wind power generation system using a stack effect of a high-speed elevator in a high-rise building according to an embodiment of the invention.

FIG. 3 is a diagram illustrating an example of a wind turbine applied to the wind power generation system according to the embodiment of the invention.

FIG. 4 is a diagram illustrating a state of the wind power generation system in use according to the embodiment of the invention.

FIG. 5 is a flow diagram illustrating a wind power generation method using a stack effect of a high-speed elevator in a high-rise building according to an embodiment of the invention.

### DESCRIPTION OF EXEMPLARY EMBODIMENTS

A wind power generation system using a stack effect of a high-speed elevator in a high-rise building according to an embodiment of the invention provides a solution for supplying energy to be used in downtown high-rise buildings with a high density using the wind power generation.

That is, the wind power generation system using a stack effect of a high-speed elevator in a high-rise building according to an embodiment of the invention can permit using as a wind power generation source an air current (wind) generated in an elevator core as a space in which a high-speed elevator car moves at the time of vertical movement of the high-speed elevator car.

The wind is generated due to the stack effect. The stack effect generates a strong upward air current due to an air density difference based on a temperature difference between the inside and the outside and thus breaks the balance of indoor air. The stack effect is great particularly in a high-rise building in winter where the temperature difference between the inside and the outside of the building is great.

For example, the stack effect causes a lobby door of a high-rise building with 30 floors or more to be hardly opened or to squeal. In this case, an elevator may be shaken, thereby giving passengers a feeling of uneasiness (particularly in winter). The stack effect is similar to the air current in a chimney and is also called chimney effect.

Hereinafter, exemplary embodiments of the invention will be described in detail with reference to the accompanying drawings.

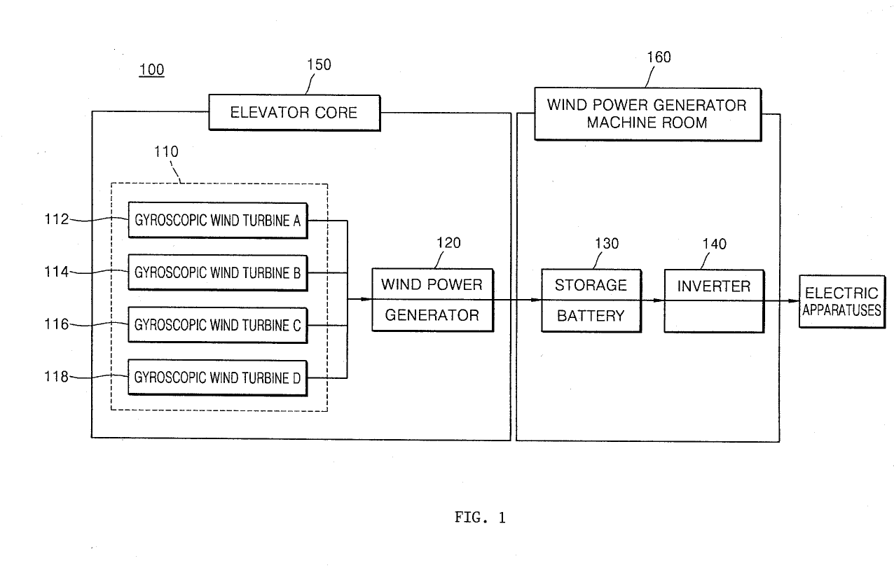

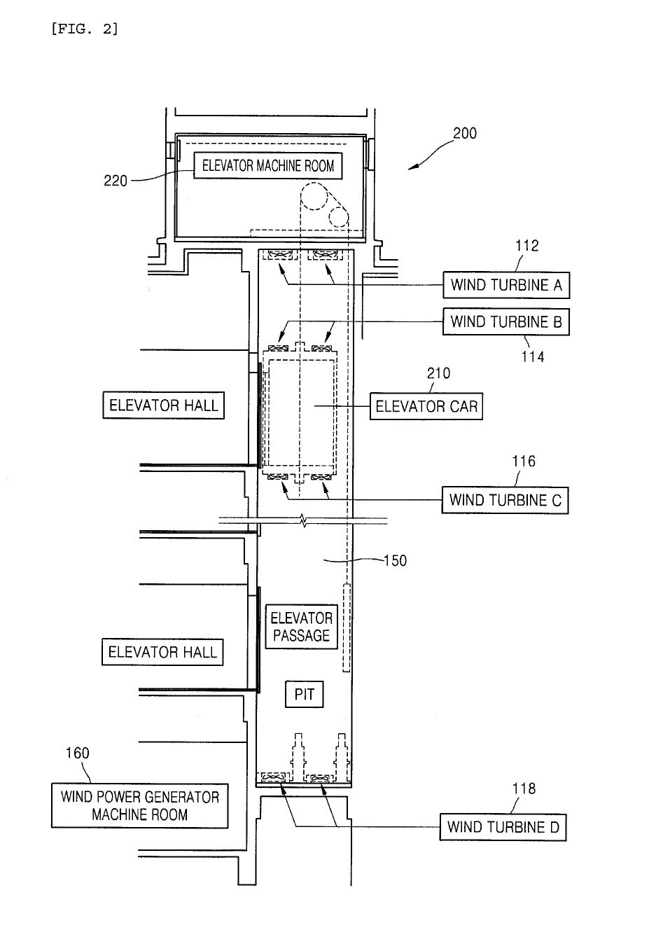

FIG. 1 is a block diagram illustrating the configuration of a wind power generation system using a stack effect of a high-speed elevator in a high-rise building according to an embodiment of the invention. FIG. 2 is a location diagram illustrating the wind power generation system using a stack effect of a high-speed elevator in a high-rise building according to an embodiment of the invention.

Referring to FIGS. 1 and 2, the wind power generation system 100 (hereinafter, referred to as “wind power generation system”) using a stack effect of a high-speed elevator in a high-rise building according to an embodiment of the invention includes a wind turbine 110, a wind power generator 120, a storage battery 130, and a converter 140.

The wind turbine 110 rotates with a wind generated by the movement of an elevator car 210 vertically moving in an internal space of an elevator core 150 disposed in a high-rise building 200. That is, the wind turbine 110 can convert the wind, that is, wind energy, in the internal space of the elevator core 150 into kinetic energy with the rotation and transmit the kinetic energy to the wind power generator 120.

Here, the wind is generated by the stack effect (or the chimney effect) as described above. The high-rise building 200 includes 20 floors or more. The elevator car 210 is embodied by a high-speed elevator car of 210 m/min or more and preferably 300 m/min or more.

The wind turbine 110 includes plural wind turbines disposed in the upper part and the lower part in the elevator core 150 and plural wind turbines disposed in the upper part and the lower part of the elevator car 210.

For example, two gyroscopic wind turbines A 112 are disposed in the upper part of the elevator core 150, and two gyroscopic wind turbine D 118 are disposed in the lower part of the elevator core 150.

More specifically, two gyroscopic wind turbines A 112 are disposed below an elevator machine room 220 disposed above the elevator core 150 so as to control the operation of the elevator car 210. Two gyroscopic wind turbines D 118 are disposed in the bottom of an elevator pit located in the lower part of the elevator core 150.

Two gyroscopic wind turbines B 114 are disposed in the top of the elevator car 210, and two gyroscopic wind turbines C 116 are disposed in the bottom of the elevator car 210.

More specifically, two gyroscopic wind turbines B 114 are disposed in the outer edge of the top of the elevator car 210. Two gyroscopic wind turbines C 116 are disposed in the outer edge of the bottom of the elevator car 210.

The wind turbine 110 includes a small-sized wind turbine which can work with a weak wind. Here, the small-sized wind turbine has, for example, the power of 50 kW or less and a diameter of 2.1 m or less. Accordingly, the small-sized wind turbine is small and light and causes a relatively small noise in comparison with a middle-sized or large-sized wind turbine.

The wind turbine 110 is physically connected to the wind power generator 120 in the elevator core 150. In the drawing, the wind power generator 120 is shown as a block. However, since 8 wind turbines 110 in total are disposed in the upper part and the lower part in the elevator core 150 and in the top and bottom of the elevator car 210, 8 wind power generators 120 in total can be provided.

In other words, the wind turbines 110, that is, two wind turbines A 112, two wind turbines B 114, two wind turbines C 116, and two wind turbines D 118, are physically connected to the wind power generators 120, respectively, so as to transmit the kinetic energy to the wind power generators 120.

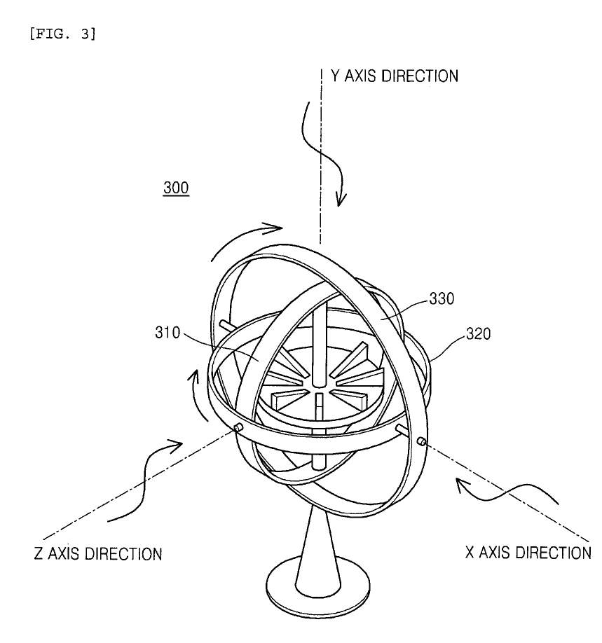

Each wind turbine 110 may have a structure in which blades having a bent rectangular plate shape are coupled between a circular upper plate and a circular lower plate which are coupled about a single axis. For example, the wind turbine 110 can be embodied by a vertical axis wind turbine such as a Darrieus turbine or a Savonius turbine. However, the wind turbine 110 may be embodied by another type of wind turbine. This case will be described in detail with reference to FIG. 3.

FIG. 3 is a diagram illustrating an example of a wind turbine applied to the wind power generation system according to an embodiment of the invention.

As shown in FIG. 3, a wind turbine 300 has a structure having plural axes, instead of a signal axis as described above.

That is, the wind turbine 300 may have a structure of a gyroscopic wind turbine in which a gimbal 310 arranged about the X axis, a gimbal 320 arranged about the Y axis, and a gimbal 330 arranged about the Z axis are coupled into a sphere shape and a rotor is formed in the gimbal 320 arranged about the Y axis.

Therefore, the wind turbine 300 can work with winds in all directions in the elevator core 150.

Referring to FIGS. 1 and 2 again, the wind power generator 120 converts the kinetic energy generated with the rotation of the wind turbine 110 into the electric energy. That is, the wind power generator 120 can generate the electric energy from the kinetic energy.

The wind power generator 120 is physically connected to the corresponding wind turbine 110 in the elevator core 150. That is, the wind power generator 120 is physically connected to the wind turbine 110 via a shaft to receive the kinetic energy from the wind turbine 110.

The wind power generator 120 may form a body with the wind turbine 110. That is, plural sets of the wind power generator 120 and the wind turbine 110 may be disposed in the upper part and the lower part of the elevator core 150 and the top and the bottom of the elevator car 210.

The storage battery 130 receives and stores the electric energy from the wind power generators 120. The storage battery 130 may be disposed in a wind power generator machine room 160 controlling the operation of the wind power generator 120.

The converter 140 converts the electric energy stored in the storage battery 130 and supplies the converted electric energy to electric apparatuses (including the elevator) in the high-rise building 200. Specifically, a voltage with a constant output level (DC voltage), for example, one of 12 V, 24 V, and 48 V, may be stored in the storage battery 130. Therefore, the converter 140 converts the voltage of the electric energy to be suitable for the electric apparatuses.

For example, it is assumed that the voltage of the electric energy stored in the storage battery 130 is a DC voltage of 24 V and an electric apparatus in the high-rise building 200 works with an AC voltage of 220 V. In this case, the converter 140 converts the DC voltage of 24 V into the AC voltage of 220 V and supplies the converted voltage to the electric apparatus.

The converter 140 can be embodied by an inverter. The converter 140 may be disposed in the wind power generator machine room 160 controlling the operation of the wind power generators 120.

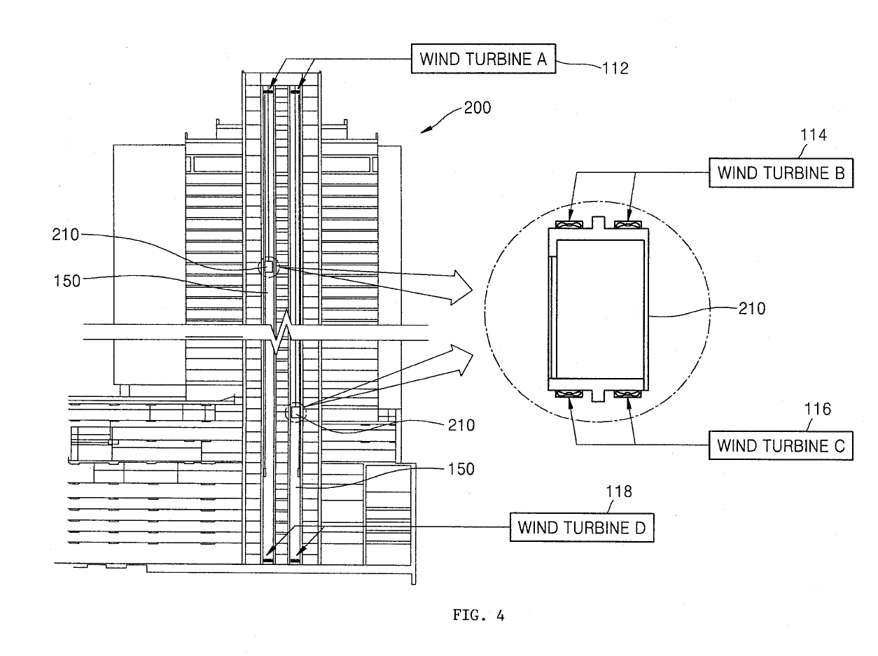

FIG. 4 is a diagram illustrating a state of the wind power generation system in use according to an embodiment of the invention.

As shown in FIG. 4, the elevator core 150 is disposed in the high-rise building 200 and the elevator car 210 vertically moves in the internal space of the elevator core 150.

A wind (air current) is generated due to the stack effect in the internal space of the elevator core 150 with the movement of the elevator car 210. The wind turbines 112, 114, 116, and 118 work with the wind.

When the elevator car 210 moves upward, the wind turbines A 112 disposed in the upper part of the elevator core 150 and the wind turbines B 114 disposed on the top of the elevator car 210 work.

On the other hand, when the elevator car 210 moves downward, the wind turbines D 118 disposed in the lower part of the elevator core 150 and the wind turbines C 116 disposed in the bottom of the elevator car 210 work.

When the wind turbines 112, 114, 116, and 118 work, the wind turbines 112, 114, 116, and 118 generate the kinetic energy, and the generated kinetic energy is transmitted to the wind power generators (see reference numeral 120 in FIGS. 1 and 2) and is converted into the electric energy.

The electric energy is stored in the storage battery (see reference numeral 130 in FIG. 1), the voltage thereof is converted by the converter (see reference numeral 140 in FIG. 1), and the resultant voltage is supplied to an electric apparatus in the high-rise building 200.

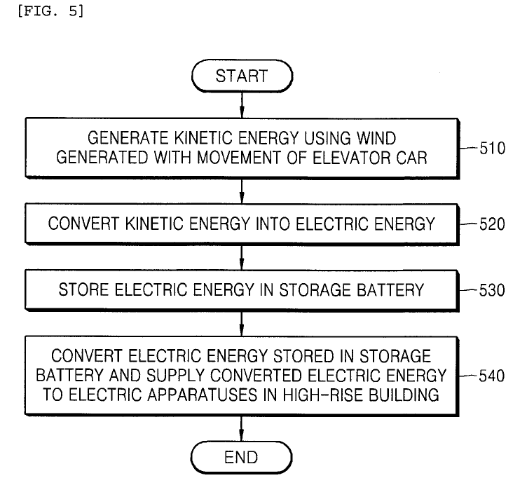

FIG. 5 is a flow diagram illustrating a wind power generation method using the stack effect of a high-speed elevator in a high-rise building according to an embodiment of the invention. Here, the wind power generation method can be carried out by the wind power generation system 110 shown in FIG. 1.

Referring to FIG. 5, the wind power generation system generates the kinetic energy using the wind generated with the vertical movement of the elevator car in the internal space of the elevator core of the high-rise building in step 510. That is, the wind power generation system can generate the kinetic energy by rotating the wind turbines using the wind generated in the elevator core.

Here, plural wind turbines may be disposed in the upper part and the lower part of the elevator core, and plural wind turbines may be disposed in the top and the bottom of the elevator car.

The wind turbine may include a small-sized wind turbine which can work with a weak wind. Here, the small-sized wind turbine has, for example, the power of 50 kW or less and a diameter of 2.1 m or less. Accordingly, the small-sized wind turbine is small and light and causes a relatively small noise in comparison with a middle-sized or large-sized wind turbine.

In step 520, the wind power generation system converts the kinetic energy into the electric energy. That is, the wind power generation system can convert the kinetic energy into the electric energy by the use of the wind power generator.

Here, the wind power generator is physically connected to the corresponding wind turbine in the elevator core. That is, the wind power generator is physically connected to the wind turbine via a shaft to receive the kinetic energy from the wind turbine.

The wind power generator may form a body with the wind turbine. That is, plural sets of the wind power generator and the wind turbine may be disposed in the upper part and the lower part of the elevator core and the top and the bottom of the elevator car.

In step 530, the wind power generation system stores the electric energy in the storage battery. Here, the storage battery may be disposed in the wind power generator machine room controlling the operation of the wind power generators.

In step 540, the wind power generation system converts the electric energy stored in the storage battery and supplies the converted electric energy to an electric apparatus (including the elevator) in the high-rise building. That is, the wind power generator system converts the voltage level of the electric energy depending on the operation voltage level of the electric apparatus by the use of the inverter and supplies the electric energy to the electric apparatus.

Here, the inverter may be disposed in the wind power generator machine room controlling the operations of the wind power generators.

In the above-mentioned wind power generation system and method according to the embodiments of the invention, it is possible to supply the electric energy generated by the wind power generation to the electric apparatus in the high-rise building by using the air current (wind) generated at the time of the vertical movement of a high-speed elevator car as a wind power generation source.

Therefore, in the wind power generation system and method according to the embodiments of the invention, it is possible to minimize the air current (wind) generated in the high-rise building due to the stack effect.

The specific embodiments of the invention have been described, but the invention can be modified in various forms without departing from the scope of the invention. Therefore, the scope of the invention is not limited to the above-mentioned embodiments, but is determined by the appended claims and equivalents of the claims.

While the invention has been described with reference to the finite embodiments and drawings, the invention is not limited to the embodiments, but it will be understood by those skilled in the art that the invention can be modified in various forms without departing from the technical spirit of the invention taught from the appended claims. Therefore, the technical spirit of the invention should be read from only the appended claims and the equivalent modifications thereof should belong to the spirit and scope of the invention.

What is claimed is:

1. A wind power generation system using a stack effect of a high-speed elevator in a high-rise building, comprising:
a wind turbine rotating with a wind generated from movement of an elevator car vertically moving in an internal space of an elevator core disposed in the high-rise building;
a wind power generator converting kinetic energy generated with the rotation of the wind turbine into electric energy; and
a storage battery storing the electric energy.

2. The wind power generation system according to claim 1, wherein the wind turbine includes a plurality of wind turbines disposed in the upper part and the lower part of the elevator core and a plurality of wind turbines disposed in the upper part and the lower part of the elevator car.

3. The wind power generation system according to claim 1, wherein the wind turbine includes a gyroscopic wind turbine in which three gimbals arranged in the X, Y, and X axis directions, respectively, are coupled into a spherical shape so as to work with winds of all directions and in which a rotor is formed in the gimbal arranged in the Y axis direction.

4. The wind power generation system according to claim 1, wherein the wind turbine includes a small-sized wind turbine which can work with a weak wind.

5. The wind power generation system according to claim 2, wherein the wind turbines disposed in the upper part and the lower part of the elevator car are located in the outer edges of the upper part and the lower part of the elevator car.

6. The wind power generation system according to claim 1, wherein the wind turbine and the wind power generator are physically connected to each other in the elevator core, and
wherein the storage battery is disposed in a wind power generator machine room controlling the operation of the wind power generator.

7. The wind power generation system according to claim 1, further comprising a converter converting the electric energy stored in the storage battery and supplying the converted electric energy to electric apparatuses in the high-rise building including the elevator.

8. A wind power generation method using a stack effect of a high-speed elevator in a high-rise building, comprising the steps of:
generating kinetic energy using a wind caused by movement of an elevator car vertically moving in an internal space of an elevator core disposed in the high-rise building;
converting the kinetic energy into electric energy; and
storing the electric energy in a storage battery.

9. The wind power generation method according to claim 8, wherein the step of generating the kinetic energy includes rotating a wind turbine using the wind to generate the kinetic energy.

10. The wind power generation method according to claim 8, further comprising a step of converting the electric energy stored in the storage battery and supplying the converted electric energy to electric apparatuses in the high-rise building including the elevator.
